(19) United States
(12) Patent Application Publication
(10) Pub. No.: US 2018/0040113 A1
(43) Pub. Date: Feb. 8, 2018

(54) APPARATUS AND METHOD FOR INSPECTING TEMPLATE BY USING SIMPLIFIED HOUGH TRANSFORM

(71) Applicant: INDUSTRY-ACADEMIC COOPERATION FOUNDATION, YONSEI UNIVERSITY, Seoul (KR)

(72) Inventors: Jae Seok KIM, Seoul (KR); Jun Won MUN, Seoul (KR); Yune Seok JANG, Incheon (KR); Yoo Jun NAM, Seoul (KR)

(73) Assignee: INDUSTRY-ACADEMIC COOPERATION FOUNDATION, YONSEI UNIVERSITY, Seoul (KR)

(21) Appl. No.: 15/657,748

(22) Filed: Jul. 24, 2017

(30) Foreign Application Priority Data
Aug. 3, 2016 (KR) 10-2016-0099070

(51) Int. Cl. G06T 7/00; G06T 7/13; G06T 7/70

(52) U.S. Cl. CPC G06T 7/001; G06T 7/70; G06T 7/13; G06T 2207/20061

(57) ABSTRACT

One embodiment of the present invention provides an apparatus and method for inspecting a template using a simplified Hough transform. An apparatus for inspecting a template using a simplified Hough transform according to an embodiment of the present invention comprises a rotation angle determination unit for determining a rotation angle of the template included in the object by performing a first voting procedure on a input image including an object; and a position determining unit for calculating a voting cumulative values for the blocks included in the input image by performing a second voting procedure on the input image, performing a down sampling at least one of the blocks based on the voting cumulative values, and determining a position of the template by performing a third voting procedure on the down sampled blocks.

### CROSS-REFERENCE TO RELATED APPLICATION

This application claims the priority benefit of Korean Patent No. 10-2016-0099070, filed on Aug. 3, 2016 in the Korean Intellectual Property Office, the disclosure of which is incorporated herein by reference.

### BACKGROUND OF THE DISCLOSURE

### Field of the Disclosure

The present invention relates to an apparatus and method for inspecting a template using a simplified Hough transform.

### Description of the Related Art

In recent manufacturing and distribution industries, a method of inspecting a product using a template matching algorithm is being implemented.

In addition, the template matching algorithm have been applied to research fields such as industrial inspection, remote sensing, face recognition, stereo matching, fingerprint matching and object tracking.

An algorithm for detecting arbitrary shapes based on edge detection, such as template matching algorithms, is a generalized Hough transform (GHT).

The generalized Hough transform according to the prior art is used for template matching. If template matching is performed using generalized Hough transform, it is possible to detect a pose, a position, and rotation angel of an object to be detected.

The template matching method using the generalized Hough Transform has excellent performance in occlusion, illumination change, noise and the like compared with other template matching methods.

However, the template matching method using the generalized Hough transform has a disadvantage that the memory amount and the calculation amount are required too much.

In addition, a 2D shape detection method using an invariant approach has been proposed to overcome the drawbacks of the template matching method using generalized Hough transform.

The 2D shape detection method using the invariant approach is to perform template matching by dividing the stage.

The 2D shape detection method using the invariant approach that is performed template matching by dividing the stage has a merit that the amount of calculation and the memory amount are reduced as compared with the template matching method using the conventional generalized Hough transform.

However, as 2D shape detection method using the invariant approach uses a method of pairing pixels, it is sensitive to environmental changes and has a disadvantage that the performance decreases as the template becomes complicated.

In addition, as a simplified generalized Hough transform method, a real-time object recognition method using a modified generalized Hough transform has been proposed.

Real-time object recognition using modified generalized Hough transform can simplify object recognition using image pyramid.

However, when the template is actually complicated, there is problem that the processing speed is reduced in hardware design, is no great effect because the pyramid level is low.

Therefore, there is a need to propose a technique that is adaptive to environmental changes, is suitable for real-time recognition or sensing, and is satisfy both high processing speed and performance.

### RELATED DOCUMENTS

### Patent Documents

Korean Patent No. 10-1482448, entitled “METHOD AND APPRATUS FOR DETECTING LINE DATE BASED ON HOUGH TRANSFORM”
Korean Patent No. 10-1244762, entitled “TRACK ASSOCIATION METHOD BASED ON HOUGH TRANSFORM AND DETECTING METHOD USING THE SAME”
Korean Patent No. 10-1546590, entitled “HOUGH TRANSFORM FOR CIRCLES”

### Non-Patent Documents

Journal: D. H. Ballard, Generalizing the Hough transform to detect arbitrary shapes, the journal of the Pattern Recognition Society
Journal: Markus Ulrich, Carsten Steger, Albert Baumgartner, Real-time object recognition using a modified generalized Hough transform, the journal of the pattern recognition society
Journal: N. Guil, J. M. Gonzalez-Linares, E. L. Zapata, Bidimensional shape detection using an invariant approach, the journal of the pattern recognition society

### SUMMARY OF THE DISCLOSURE

The present invention seeks to provide an apparatus and method for inspecting a template using a simplified Hough transform.

An object of the present invention is to provide an apparatus and a method for detecting an outline of an object with block units based on a horizontal axis, a vertical axis and a diagonal axis.

The present invention provides an apparatus and method for performing voting on first blocks corresponding to a diagonal axis of an outline in a first step.

The present invention provides an apparatus and method for calculating the first voting cumulative values for first blocks in a first step and determining a rotation angle of template based on the calculated first voting cumulative values.

In the second step, the present invention provides an apparatus and method for performing voting for the second blocks corresponding to the horizontal axis and the third blocks corresponding to the vertical axis among the blocks corresponding to the edge, calculating the second cumulative values for the second blocks and the third blocks, down sampling the blocks corresponding to the maximum value among the second voting cumulative values, performing voting for the fourth blocks including the down sampled block, calculating the third voting cumulative values for the fourth blocks and determining a position of template based on the maximum values among the second voting cumulative values and the maximum values among the third voting cumulative values.

The present invention provides an apparatus and method for inspecting the template based on the rotation angle and position of the template.

An apparatus for inspecting a template using a simplified Hough transform according to an embodiment of the present invention comprises a rotation angle determination unit for determining a rotation angle of the template included in the object by performing a first voting procedure on a input image including an object; and a position determining unit for calculating a voting cumulative values for the blocks included in the input image by performing a second voting procedure on the input image, performing a down sampling at least one of the blocks based on the voting cumulative values, and determining a position of the template by performing a third voting procedure on the down sampled blocks.

The method of inspecting a template using a simplified Hough transform according to an embodiment of present invention comprises for determining a rotation angle of the template included in the object by performing a first voting procedure on a input image including an object; calculating a voting cumulative values for the blocks included in the input image by performing a second voting procedure on the input image; performing a down sampling at least one of the blocks based on the voting cumulative values; determining a position of the template by performing a third voting procedure on the down sampled blocks.

An apparatus and method for inspecting a template using a simplified Hough transform according to an exemplary embodiment of the present invention includes two steps in detecting the position and rotation angle of a template.

An apparatus and method for inspecting a template using a simplified Hough transform includes calculating a rotation angle of a template by performing voting on blocks corresponding to a diagonal axis of the object in a first step, sampling the blocks corresponding to the maximum value on the basis of the result of the voting in the second step and performing the voting on the down sampled blocks again, and the template is inspected based on the calculated rotation angle and position.

Accordingly, an apparatus and method for inspecting a template using a simplified Hough transform has an effect of reducing a memory amount and a calculation amount required for inspecting a template included in an object.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a block diagram of electronic device according to an embodiment of the present invention.

FIG. 2 illustrates an operational procedure of electronic device according to an embodiment of the present invention.

FIG. 3 illustrates an operational procedure of electronic device according to another embodiment of the present invention.

FIG. 4 illustrates an operational procedure of electronic device according to another embodiment of the present invention.

FIG. 5 illustrates an operational procedure of electronic device according to another embodiment of the present invention.

FIGS. 6A and 6B illustrate blocks in which double voting is performed to determine the position of template according to another embodiment of the present invention.

### DETAILED DESCRIPTION OF THE DISCLOSURE

Hereinafter, various embodiments of the present document will be described with reference to the accompanying drawings. It is understood that the embodiments and terminologies used herein are not intended to limit the techniques described in this document to specific embodiments, but rather to include various modifications, equivalents, and/or alternatives of the embodiments.

In the following description, well-known functions or constructions are not described in detail since they would obscure the invention in unnecessary detail.

It is understood that both the foregoing general description and the following detailed description of the present invention are exemplary and explanatory and are intended to provide further explanation of the invention as claimed. Therefore, the definition should be based on the contents throughout this specification.

In the context of the description of the drawings, similar reference numerals may be used for similar elements.

The singular expressions may include plural expressions unless the context clearly dictates otherwise.

In this document, the expressions “A or B” or “at least one of A and/or B” and the like may include all possible combinations of the items listed together.

Expressions such as “the 1,” “the 2,” “the first,” or “the second,” and the like, may qualify the components irrespective of order or importance and may be used to distinguish one component from another, but is not limited to those components.

When it is mentioned that some (e.g., the first) component is “(functionally or communicatively) connected” or “accessed to” another (e.g., the second) component, it may be directly connected to the component, or may be connected through another component (e.g., the third component).

In this specification, as herein “is intended to configured to” is used to do interchangeably all types of information, including, for example, with hardware or software, “suitable for ˜”, “capable of ˜”, “changed to ˜”, “made to ˜”, or “designed to ˜.”

In some situation, the phrase “configured to ˜” can also mean the device “capable of ˜” with the device, other device or components.

For example, the phase “a processor composed (or configured) to perform A, B, and C” may mean a general purpose processor (e.g., a CPU or an application processor) capable of performing the corresponding operations by executing one or more software programs stored in a memory device or a dedicated processor (e.g., an embedded processor).

Also, the term ‘or’ means inclusive or ‘inclusive or’ rather than ‘exclusive or’. That is, unless expressly stated otherwise or clear from the context, the expression ‘x uses a or b’ means any of the natural inclusive permutations

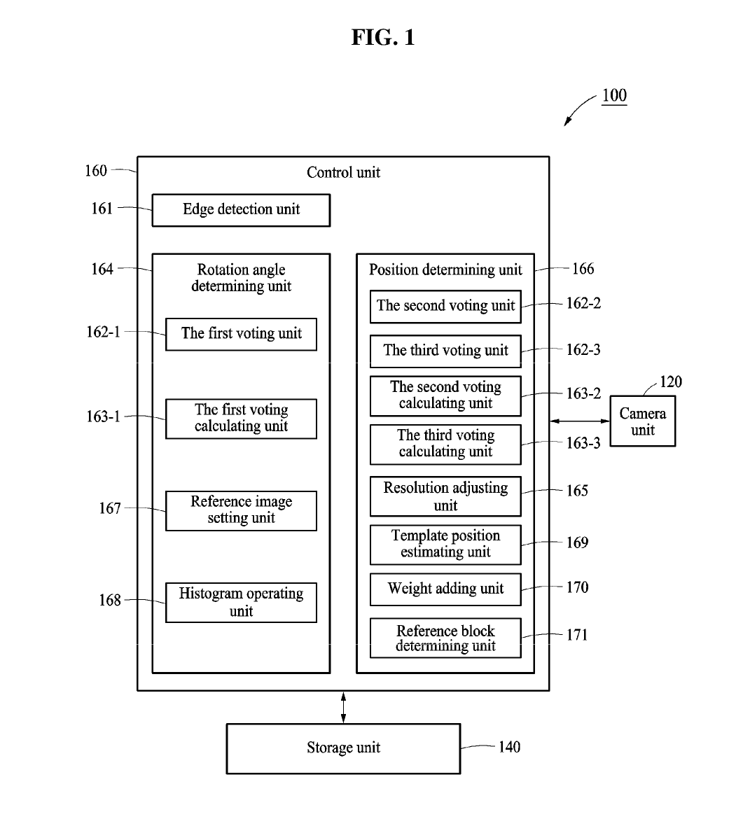

FIG. 1 illustrates a block diagram of an electronic device according to an embodiment of the present invention.

In particular, FIG. 1 illustrates components of an electronic device according to one embodiment of the present invention.

For example, the electronic device 100 may be referred to as an apparatus for inspecting a template using a generalized Hough transform.

The terms ‘ . . . part’, ‘ . . . unit’ and the like used below are used to denote at least one unit for processing a function or an operation, and may be implemented by hardware, software, or a combination of hardware and software.

Hereinafter, for convenience of explanation, the electronic device 100 will be described as an apparatus for inspecting a template using a simplified Hough transform.

Referring to FIG. 1, the electronic device 100 includes a camera unit 120, a storage unit 140, and a control unit 160.

The camera unit 120 is a device for capturing still images and moving images.

For example, the camera unit 120 may include one or more image sensors (e.g., front or rear sensor), a lens, an image signal processor (ISP), or a flash (e.g., LED or xenon lamp).

For example, the camera unit 120 may be a camera driver among the device drivers.

For example, the device driver may include a display driver, a Bluetooth driver, a shard memory driver, a USB driver, a keypad driver, a WiFi driver, an audio driver, or inter-process communication (IPC) driver.

The camera unit 120 according to an exemplary embodiment of the present invention may capture an object including a template.

For example, the template may be referred to as the object to be inspected and may be the material to be inspected while being mass produced in a certain shape of industrial products and then moved through the conveyor belt.

For example, the object may be a generating material including template to be inspected.

For example, the object may be an image including the template to be inspected.

For example, objects and templates can be identified by edges.

The storage unit 140 may include volatile and/or non-volatile memory.

The storage unit 140 may store instructions or data related to at least one other component of the electronic device 100.

For example, the storage unit 140 may store software and/or programs. For example, the program may include a kernel, a middleware, an application programming interface and/or an application program.

At least a portion of the kernel, middleware, or application interface (API) may be referred to as the operating system. For example, the kernel may control or manage system resources (such as a bus, processor, or memory) used to perform operations or functions implemented in other programs (e.g., middleware, API, or application programs).

In addition, the kernel may provide an interface to control or manage system resources by accessing individual components of the electronic device 100 in a middleware, API, or application program.

For example, the storage unit 140 may include an internal memory or an external memory.

For example, the internal memory may include at least one of volatile memory (e.g., DRAM, SRAM, SDRAM or the like), non-volatile memory (e.g., one time programmable ROM), PROM, EPROM, EEPROM, mask ROM, flash ROM, flash memory, Hard drive, solid state drive (SSD) or the like.

For example, the external memory may be a flash drive, such as a compact flash (CF), a secure digital (SD), a Micro-SD, a Mini-SD, an extreme digital (xD), multi-media card (MMC), a memory stick or the like.

For example, the external memory may be functionally or physically connected to the electronic device 100 through various interfaces.

For example, the storage unit 140 may store information for a first voting cumulative values of a first blocks corresponding to a diagonal axis of an edge of an object.

For example, the storage unit 140 may store information for a rotation angle determined based on the first voting cumulative values.

For example, the storage unit 140 may store information for the second voting cumulative values for the second blocks corresponding to a horizontal axis and the third blocks corresponding to a vertical axis of the edge of the object.

For example, the storage unit 140 may store information of a block related to a maximum value among the second voting cumulative values.

For example, the storage unit 140 may store information of a block related to a maximum value among the third voting cumulative values.

For example, the storage unit 140 may store information related to the location of the template among the blocks corresponding to the edge of the object.

For example, the storage unit 140 may store information of the first reference block and the second reference block determined by a reference block determining unit 171.

For example, the storage unit 140 may store information of a position of the template determined based on a maximum value among the second voting cumulative values and a maximum value among the third voting cumulative values.

For example, the storage unit 140 may detect the edge of the object with block units based on the horizontal axis, the vertical axis, and the diagonal axis by the edge detection unit 161.

For example, the storage unit 140 may store information of the first voting cumulative values calculated for the first blocks by a first voting calculating unit 163-1.

For example, the storage unit 140 may store information of the second voting cumulative values calculated for the second blocks by the second voting calculator.

For example, the storage unit 140 may store information of the third voting cumulative values calculated for the fourth blocks by the third voting calculator.

The storage unit 140 may store information of a reference values for performing down sampling.

The control unit 160 includes an edge detection unit 161, a rotation angle determining unit 164, and a position determination unit 166.

The control unit 160 may include a processor, a central processing unit, an application processor, or a communication processor.

For example, the control unit 160 may control the operation of the electronic device 100 performed by the camera unit 120 and the storage unit 140.

For example, the control unit 160 may perform operations and data processing related to control and/or communication of at least one other component of the electronic device 100.

For example, the control unit 160 may control a plurality of hardware or software components connected to the controller 160 by driving an operating system or an application program, and may perform various data processing and calculations.

For example, the control unit 160 may implemented as a system on chip (SOC). The control unit 160 may load and process the command or data received from at least one of the other components (e.g., non-volatile memory) into the volatile memory and store the resulting data in the non-volatile memory.

The control unit 160 according to an embodiment of the present invention can determine the rotation angle and the position of the template by dividing the first step for determining the rotation angle of the template and the second step for determining the position of the template.

The edge detection unit 161 according to an embodiment of the present invention can detect the edges of an object as block units based on a horizontal axis, a vertical axis, and a diagonal axis.

The edge detection unit 161 according to an embodiment of the present invention can detect the edge of the template as block units based on the horizontal axis, the vertical axis, and the diagonal axis.

For example, the horizontal axis may referred to as the x-axis, the vertical axis may referred to as the y-axis, and the diagonal axis may referred to as the theta axis.

For example, the edge of the object may be located on a three-dimensional plane that separated based on a horizontal axis, a vertical axis, and a diagonal axis.

The rotation angle determining unit 164 includes a first voting unit 162-1.

The first voting unit 162-1 according to an embodiment of the present invention may perform voting on first blocks corresponding to the diagonal axes of the edge determined based on the horizontal axis, the vertical axis, and the diagonal axis.

For example, the first voting unit 162-1 may perform voting on an object corresponding to the rotation angle of the template among the first blocks corresponding to the diagonal axis of the edge.

For example, the first voting cumulative values according to a result voted by the first voting unit 162-1 may use to determine the rotation angle of the template.

The position determining unit 166 includes a second voting unit 162-2 and a third voting unit 162-3.

The second voting unit 162-2 may perform voting on the second blocks corresponding to the horizontal axis of edge and the third blocks corresponding to the vertical axis of edge.

For example, the second voting cumulative values according to a result voted by the second voting unit 162-2 can use to determine the position of the template.

The third voting unit 162-3 may perform voting on the blocks included in the block corresponding to the maximum value among the second voting cumulative values.

For example, blocks included in the block corresponding to the maximum value among the second voting cumulative values may referred to as the fourth blocks.

For example, the third voting cumulative values according to the result voted by the third voting unit 162-3 may use to determine the location of the template.

For example, the third voting unit 162-3 may perform voting on the fourth blocks in consideration of the weight added to the blocks.

For example, the third voting unit 162-3 may perform voting on the fourth blocks with reference to the maximum value among the second cumulative values in the second step.

For example, the blocks to be voting by the first voting unit 162-1, the second voting unit 162-2, and the third voting unit 162-3 may be a matrix dividing into a horizontal axis, a vertical axis, and a diagonal axis.

The rotation angle determining unit 164 includes the first voting calculator 163-1.

The first voting unit 162-1 according to an embodiment of the present invention may perform voting on the first blocks corresponding to the diagonal axes of the edge determined based on the horizontal axis, the vertical axis, and the diagonal axis.

For example, the first voting unit 162-1 may perform voting on the object corresponding to the rotation angle of the template among the first blocks corresponding to the diagonal axis of the edge.

For example, the first voting cumulative values according to a result voted by the first voting unit 162-1 may use to determine the rotation angle of the template.

The position determining unit 166 includes the second voting unit 162-2 and the third voting unit 162-3.

The second voting unit 162-2 may perform voting on the second blocks corresponding to the horizontal axis and the third blocks corresponding to the vertical axis of the edge.

For example, the second voting cumulative values according to a result voted by the second voting unit 162-2 can use to determine the position of the template.

The third voting unit 162-3 may perform voting on the blocks included in the block corresponding to the maximum value among the second voting cumulative values.

For example, blocks included in the block corresponding to the maximum value among the second voting cumulative values may be referred to as the fourth blocks.

For example, the third voting cumulative values according to a result voted by the third voting unit 162-3 may use to determine the location of the template.

For example, the third voting unit 162-3 may perform voting on the fourth blocks in consideration of the weight added to the blocks.

For example, the third voting unit 162-3 may perform voting on the fourth blocks with reference to the maximum value among the second cumulative values in the second step.

For example, the blocks to be voted by the first voting unit 162-1, the second voting unit 162-2, and the third voting unit 162-3 may be a matrix dividing into a horizontal axis, a vertical axis, and a diagonal axis.

The rotation angle determining unit 164 includes a first voting calculating unit 163-1. The first voting calculating unit 163-1 according to an embodiment of the present invention can calculate the voting result for the first blocks corresponding to the diagonal axis of the edge as the first voting cumulative values.

The position determining unit 166 includes a second voting calculating unit 163-2 and a third voting calculating unit 163-3.

The second voting calculating unit 163-2 according to an embodiment of the present invention calculates the second voting cumulative values representing the voting result for the second blocks corresponding to the horizontal axis and for the third blocks corresponding to the vertical axis of the edge.

After down sampling the block corresponding to the maximum value among the second voting cumulative values, the third voting calculating unit 163-3 according to an embodiment of the present invention calculates the third voting cumulative values representing the voting result for the fourth blocks including the down sampled blocks.

For example, down sampling refers to a lowing technique a higher resolution to a lower resolution by compressing the resolution of an image

For example, when down sampling is performed on specific blocks, the specific blocks performed down sampling can represent all the blocks included in the specific blocks.

For example, the maximum of the second voting cumulative values and the maximum of the third voting cumulative values may use to determine the location of the template.

The rotation angle determining unit 164 may determine a rotation angle of the template included the object by performing the first voting procedure on the input image including the object.

The rotation angle determining unit 164 may determine the rotation angle of the template based on the first voting cumulative values that are the voting results performed on the first blocks corresponding to the diagonal axes of the edge by the first voting unit.

For example, the rotation angle of the template is a value indicating the degree of rotation of the template compared between the preset reference value and the measured angle.

In the first step, the rotation angle determining unit 164 according to an embodiment of the present invention calculates the rotation angle of the template based on the correlation value between the histograms representing the object including the image and template, regardless of the size of template and the symmetry relation between template and reference image.

The position determining unit 166 includes a resolution adjusting unit 165.

The resolution adjusting unit 165 according to the embodiment of the present invention may perform down sampling on the block corresponding to a maximum value among the second voting cumulative values in the second step.

For example, down sampling refers to an image processing technique that compresses from an image composed with 100 pixels to an image composed with 50 pixels.

In addition, in case down sampling is performed, the resolution is lowered and the configuration of blocks corresponding to a specific region may be identified in more detail.

The resolution adjusting unit 165 according to the embodiment of the present invention may perform down sampling for the cumulative matrix corresponding to the maximum value among the second voting cumulative values.

The position determining unit 166 according to an embodiment of the present invention calculates voting cumulative values for the blocks included input image by performing the second voting procedure of input image, performs down sampling at least one of the blocks among blocks based on voting cumulative values, and determines the position of the template by performing the third voting procedure for the down sampled block.

The position determining unit 166 according to an embodiment of the present invention may determine the position of the template based on the maximum values among the second voting cumulative values and the maximum values among the third voting cumulative values in the second step.

According to another embodiment of the present invention, the control unit 160 may include a template inspecting unit. The template inspecting unit may inspect the template based on the rotation angle and position of the template.

For example, the template inspecting unit can determine whether the template is in a normal state by comparing the information about the template stored in the storage unit 140 with the rotation angle and position of the template determined by the electronic device 100.

For example, if the template information stored in the storage unit 140 and the rotation angle and position of the template determined by the electronic device 100 are identical or similar within the reference range, the template inspecting unit determines the normal state.

For example, when the information about the template stored in the storage unit 140 and the rotation angle and the position of the template determined by the electronic device 100 are not identical, the template inspecting unit determines an abnormal state.

According to another embodiment of the present invention, the control unit 160 may include a reference image setting unit.

For example, the reference image setting unit 167 can set a reference image that can include the object.

For example, the reference image may be a printed circuit board (PCB).

For example, the reference image may include an object including the template and a background image located around the object.

The position determining unit 166 includes a histogram operating unit 168.

In the first step, the histogram operation unit 168 according to an embodiment of the present invention converts the object and the reference image into a histogram, and calculates a histogram correlation value between the object and the reference image.

The position determining unit 166 includes a template position estimating unit 169.

The template position estimating unit 169 according to an embodiment of the present invention can estimate blocks in which the template can be located among the blocks corresponding to the edge.

For example, the template position estimating unit 169 estimates the template positions by referencing the maximum values among the second voting cumulative values representing voting results for the second blocks corresponding to the horizontal axis the third blocks corresponding to the vertical axis of the object by the second voting unit 162-2.

For example, the position of the template estimated by the template position estimating unit 169 may be the center of the template.

The position determining unit 166 may include a reference block determining unit 171.

For example, the reference block determining unit 171 may determine, as a first reference block, a block corresponding to a maximum value of the second voting cumulative values in the second step.

For example, the reference block determining unit 171 may determine, as a second reference block, a block corresponding to a maximum value among the third voting cumulative values in the second step.

For example, the first reference block may be located at a center position among the blocks subjected to the second voting.

For example, the second reference block may be located at a center position among the blocks subjected to the third voting.

For example, blocks may compute with pixel units and may compute as an accumulation matrix.

The position determination unit 166 may include a weight adding unit 170.

The weight adding unit 170 according to an embodiment of the present invention may add weights to blocks in which the template may be located.

For example, the weight adding unit 170 may add a weight to a position estimated by the template position estimating unit 169.

For example, the weight added by the weight adding unit 170 may be considered by the third voting unit 163-3.

In the above description, each component has been described for convenience of explanation, but the above-described operations and procedures are performed by the control unit 160.

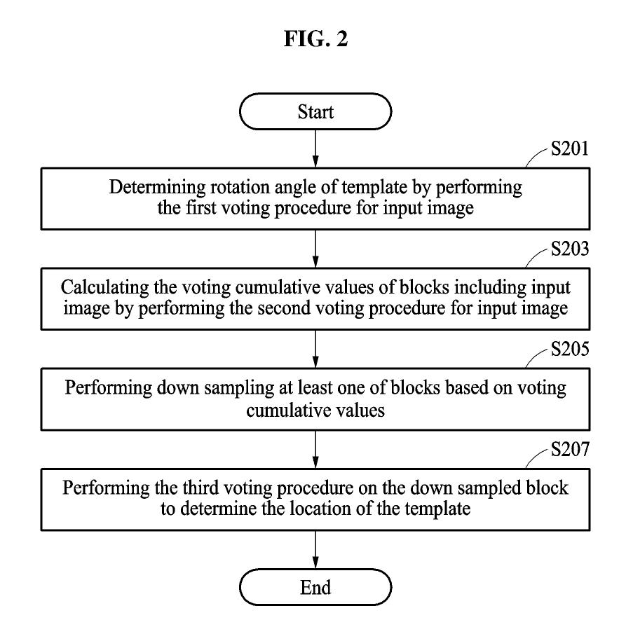

For example, the control unit 160 may control the electronic device 100 to perform the procedures shown in FIGS. 2, 3, 4, 5, and the like.

FIG. 2 shows an operational procedure of the electronic device according to an embodiment of the present invention.

Specifically, FIG. 2 illustrates an operational procedure for an electronic device to determine the rotation angle of the template as performing a first voting procedure, and determine the location of the template as performing the second and third voting procedure.

Referring to FIG. 2, in step 201, the electronic device determines the rotation angle of the template as performing the first voting procedure on the input image.

For example, the electronic device can acquire an image of an object located at a specific position using the camera unit.

The electronic device senses the edge of the object in the input image and divides the detected edge into a horizontal axis, a vertical axis, and a diagonal axis.

The electronic device may perform the first voting procedure on the blocks corresponding to the diagonal axis of the edge.

The electronic device may determine the rotation angle of the template included the object based on the voting cumulative values that are the result value of the first voting procedure.

In step 203, the electronic device calculates the cumulative values of the blocks included the input image by performing the second voting procedure on the input image.

For example, the electronic device performs the second voting procedure on the blocks corresponding to the horizontal and vertical axes of the sensed edge.

The electronic device performs voting on the blocks corresponding to the horizontal axis and the vertical axis of the detected edge, and calculates the voting cumulative values. Here, the voting for the blocks corresponding to the horizontal axis and the vertical axis may be referred to as the second voting.

In step 205, the electronic device performs down sampling at least one of the blocks based on the voting cumulative values.

For example, the electronic device performs down sampling a block corresponding to the maximum value of the voting cumulative values.

For example, the voting cumulative values according to the second voting procedure may be referred to as the second voting cumulative values.

In step 207, the electronic device performs the third voting procedure on the down sampled block to determine the location of the template.

For example, the electronic device can perform the third voting procedure on the blocks included in the down sampled block.

For example, the electronic device preform voting the blocks included in the down sampled block, calculate the voting cumulative values as the result of the voting, and determine the maximum value among the calculated voting cumulative values.

For example, the voting cumulative values according to the third voting procedure may be referred to as the third voting cumulative values.

For example, the electronic device can determine the position of the template by considering the maximum value among the second voting cumulative values and the maximum value among the third voting cumulative values.

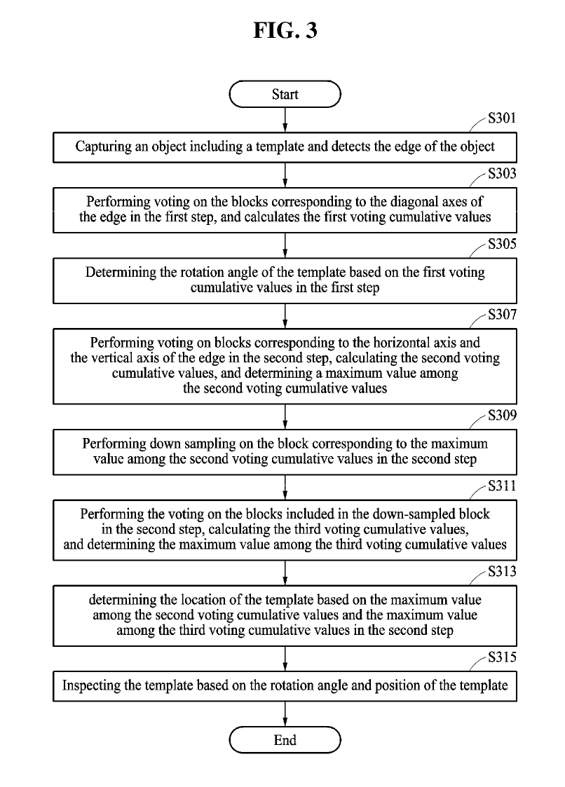

FIG. 3 shows an operational procedure of an electronic device according to another embodiment of the present invention.

Specifically, FIG. 3 shows the operation procedure of template inspecting in which the electronic device determines the rotation angle of the template in the first step and determines the position of the template in the second step by the template inspection processing composed of the first step and the second step.

Referring to FIG. 3, in the step 301, the electronic device captures an object including a template and detects the edge of the object.

The electronic device can image an object located at a specific position through camera unit.

For example, an object captured by the camera unit may include a template.

The electronic device can sense the edge of the object through the edge detection unit. Here, the edge represents the border of the object, and the template included by the object may also have an edge.

For example, the edge detection unit can detect the edge of the template.

Also, the electronic device can detect the edge of the object on a block-by-block-basis through the edge detection unit. That is, the electronic device can detect the edge of the object as blocks through the edge detection unit.

For example, the electronic device can sense an edge of an object including a template on a block-by-block basis based on a horizontal axis, a vertical axis, and a diagonal axis through an edge detection unit.

In step 303, the electronic device performs voting on the blocks corresponding to the diagonal axes of the edge in the first step, and calculates the first voting cumulative values.

The electronic device may perform voting on the first blocks corresponding to the diagonal axis of the edge of the object through the first voting unit in the first step to determine the rotation angle of the template.

For example, the first voting unit may perform voting at a position where it is determined that the template is positioned for the first blocks corresponding to the diagonal axis of the edge of the object.

The electronic device may calculate the first voting cumulative values as the voting result values for the first blocks through the first voting calculating unit.

In step 305, the electronic device determines the rotation angle of the template based on the first voting cumulative values in the first step.

For example, the electronic device may determine the rotation angle of the template, which indicates the degree to which the template is rotated according to the degree of the first voting cumulative values.

In step 307, the electronic device performs voting on blocks corresponding to the horizontal axis and the vertical axis of the edge in the second step, calculates the second voting cumulative values, and determines a maximum value among the second voting cumulative values.

In the second step for determining the position of the template, the electronic device can perform voting on the second blocks corresponding to the horizontal axis and the third blocks corresponding to the vertical axis of the edge through the second voting unit.

The electronic device can calculate the second voting cumulative values from the blocks subjected to the voting through the second voting unit in the second step.

The electronic device can determine the maximum value among calculated the second voting cumulative values and determine the block corresponding to the maximum value.

In step 309, the electronic device performs down sampling on the block corresponding to the maximum value among the second voting cumulative values in the second step.

The electronic device can perform down sampling on the block corresponding to the maximum values of the second voting cumulative values through the resolution adjusting unit in the second step.

For example, down sampling refers to a technique of lowering it from a higher resolution to a lower resolution as compressing pixels representing the resolution of an image.

For example, when down sampling is performed on specific blocks, specific blocks performed by down-sampling can represent all the blocks included in the specific block.

For example, the electronic device may perform down sampling on a block corresponding to a maximum value among the second voting cumulative values, thereby representing blocks included in a block corresponding to maximum values of the second voting cumulative values.

In step 311, the electronic device performs voting on the blocks included in the down-sampled block in the second step, calculates the third voting cumulative values, and determines the maximum value among the third voting cumulative values.

In the second step for determining the position of the template, the electronic device can perform voting on the fourth blocks included in the block corresponding to the maximum value of the second voting cumulative values through the third voting unit.

The electronic device can calculate the third voting cumulative values from the blocks subjected to the voting through the third voting unit in the second step.

The electronic device determines a maximum value among calculated the third voting cumulative values and determines a block corresponding to the maximum value.

For example, the electronic device may perform voting on the fourth blocks in consideration of the maximum value of the second voting cumulative values through the third voting unit.

In step 313, the electronic device may determine the location of the template based on the maximum value among the second voting cumulative values and the maximum value among the third voting cumulative values in the second step.

The electronic device performs voting through the third voting unit on the blocks included in the block corresponding to the maximum value among the second voting cumulative values and calculates the third voting cumulative values from the block performed voting.

The electronic device can determine the position of the block corresponding to the maximum value among the second voting cumulative values as the center position of the template.

The electronic device can estimate the position of the template using the second voting cumulative values and can determines the exact position of the template by determining the position of the corrected template using the third voting cumulative values for the estimated position.

In step 315, the electronic device inspects the template based on the rotation angle and position of the template.

For example, the electronic device can determine a inspection reference image for inspecting the template.

For example, the electronic device can inspect the template by comparing the rotation angle of the template determined in the first step and the position of the template determined in the second step with the rotation angle and position of the inspection reference image.

Further, an algorithm for the electronic device to compare the rotation angle and position of the template with the inspection reference image can be expressed by Equation (1).

$${N}_{s} \cdot {N}_{θ} + {\sum }_{i = 1}^{{N}_{θ}} \frac{{N}_{s}}{{N}_{θ}} \cdot \frac{{N}_{t}}{{N}_{θ}} = {N}_{s} \cdot {N}_{θ} + \frac{{N}_{s} {N}_{t}}{{N}_{θ}} \qquad [ Equation 1 ]$$

According to Equation (1), Nₛ represents the number of edges, N_{θ} represents the diagonal axis of the edge, and Nₜ represents the number of edges. Further, N_{θ} can be used to calculate the rotation angle of the template. Further, Nₛ·N_{θ} can represent the rotation angle of the template.

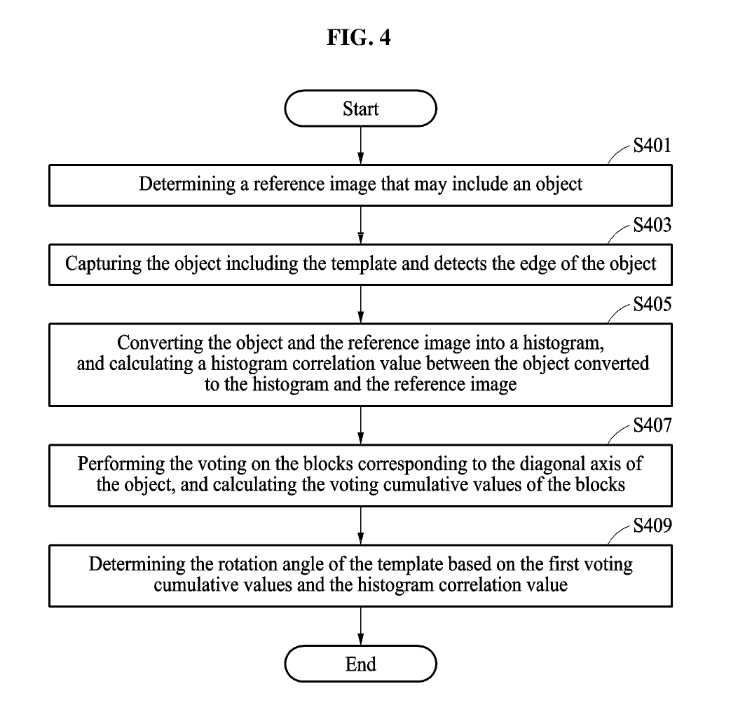

FIG. 4 shows an operational procedure of an electronic device according to another embodiment of the present invention.

Specifically, FIG. 4 illustrates an example of operation procedure in which the electronic device determines a reference image for inspecting a template, converts the object including the template and the reference image with a histogram, performs a histogram correlation operation, and determines the rotation angle of the template based on the histogram correlation value.

Referring to FIG. 4, in step 401, the electronic device determines a reference image that may include an object.

For example, a reference image may include an object and a background image to be located around the object.

For example, the reference image may include both a template, an object, a background image, and the like.

In step 403, the electronic device captures the object including the template and detects the edge of the object.

The electronic device can image the object located at a specific position through the camera unit.

For example, an object captured by the camera unit may include the template.

The electronic device can sense the edge of the object through the edge detection unit.

For example, an edge represents the border of object, and the template including the object may also have an edge.

For example, the electronic device can detect the edge of an object on a block-by-black basis through an edge detection unit.

In step 405, the electronic device converts the object and the reference image into a histogram, and calculates a histogram correlation value between the object converted to the histogram and the reference image.

The electronic device can calculate the histogram correlation value between the object and the reference image by comparing the histogram corresponding to the object with the histogram corresponding to the reference image.

In step 407, the electronic device performs voting on the blocks corresponding to the diagonal axis of the object, and calculates the voting cumulative values of the blocks.

For example, an electronic device can perform a voting on blocks corresponding to a diagonal axis of an object by referring to a histogram correlation value between an object and the reference image.

The electronic device can perform the voting on blocks corresponding to the diagonal axis through the first voting unit of the object.

The electronic device may calculate the first voting cumulative values from the blocks voted through the first voting unit.

In step 409, the electronic device determines the rotation angle of the template based on the first voting cumulative values and the histogram correlation value.

For example, the electronic device may determine the rotation angle of the template in consideration of the magnitude of the first voting cumulative values and the magnitude of the histogram correlation value.

For example, the electronic device may determine the rotation angle of the template in consideration of the maximum value of the first voting cumulative values.

For example, the electronic device can determine the rotation angle of the template based on the histogram correlation value regardless of the size of the template.

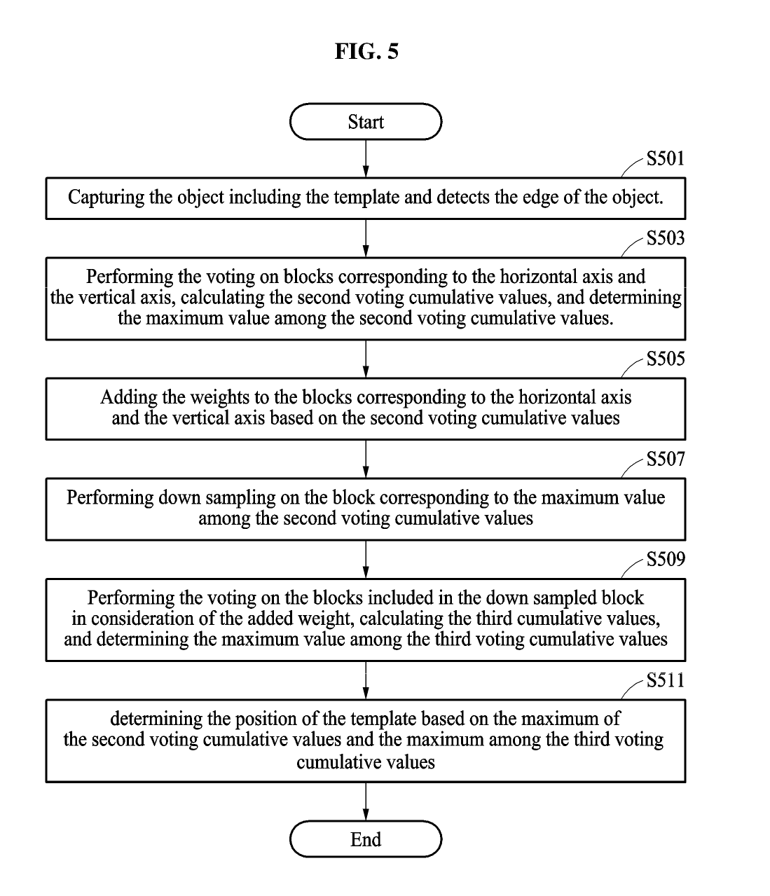

FIG. 5 illustrates an operational procedure of the electronic device according to another embodiment of the present invention.

Specifically, FIG. 5 illustrates an example of operational procedure in which the electronic device adds the weight in consideration the second voting cumulative values for the second blocks corresponding to the horizontal axis and the third blocks corresponding to the vertical axis of the object, calculating the third voting cumulative values by performing voting in consideration the added voting weight, determines the location of the template based on the maximum value among the second voting cumulative values and the maximum value among the third voting cumulative values.

Referring to FIG. 5, in step 501, the electronic device captures the object including the template and detects the edge of the object.

The electronic device can image the object located at a specific position through the camera unit.

For example, an object captured by the camera unit may include the template.

The electronic device can sense the edge of the object through the edge detection unit.

For example, the electronic device can detect the edge of an object on a block-by-block basis through an edge detection unit.

The electronic device can detect the edge of the object as blocks through the edge detection unit.

For example, the electronic device can sense the edge of the object including a template on a block-by-block basis based on a horizontal axis, a vertical axis, and a diagonal axis through an edge detection unit.

In step 503, the electronic device performs the voting on blocks corresponding to the horizontal axis and the vertical axis, calculates the second voting cumulative values, and determines the maximum value among the second voting cumulative values.

The electronic device can perform the voting on the second blocks corresponding to the horizontal axis and the third blocks corresponding to the vertical axis of the edge through the second voting unit to determine the position of the template.

The electronic device may calculate the second voting cumulative values from the blocks subjected to the voting through the second voting unit.

In step 505, the electronic device adds the weights to the blocks corresponding to the horizontal axis and the vertical axis based on the second voting cumulative values.

The electronic device determines that the template can be positioned with respect to the position having the high value among the second voting cumulative values and adds the weight to the position.

For example, the electronic device may add weights to blocks that the template may be located.

For example, the electronic device assumes that the rotation angle of the template is not different from the rotation angle of the comparison object for inspecting the template.

For example, the electronic device can add a weight to blocks judged as the position of the template, as assuming the object for inspecting the template and the template are measured at the same rotation angle.

In step 507, the electronic device performs down sampling on the block corresponding to the maximum value among the second voting cumulative values.

The electronic device may perform down sampling on a block corresponding to a maximum value of the second voting cumulative values.

For example, down sampling refers to a technique of lowering it from a higher resolution to a lower resolution as compressing pixels representing the resolution of an image.

For example, the electronic device may represent blocks included in a block corresponding to a maximum value of the second cumulative values by performing down sampling on a block corresponding to a maximum value among the second cumulative values.

In step 509, the electronic device performs the voting on the blocks included in the down sampled block in consideration of the added weight, calculates the third cumulative values, and determines the maximum value among the third voting cumulative values.

The electronic device may perform the voting on the fourth blocks included in the down sampled block by considering the weight added to the fourth blocks through the third voting unit.

The electronic device can calculate the third voting cumulative values representing the result performed on the fourth blocks through the third voting unit.

For example, the electronic device can perform the voting through the third voting unit on the blocks included in the block corresponding to the maximum value among the second voting cumulative values, and calculate the third voting cumulative values from the voting blocks.

The electronic device may determine a maximum value among the third voting cumulative values.

In addition, the maximum value of the second voting cumulative values must have the voting cumulative values which is necessarily higher than the maximum value of the third voting cumulative values.

The voting cumulative values can be represented by a cumulative matrix. The size of the cumulative matrix according to an embodiment of the present invention can be expressed by Equation (2). Equation 2 is as follows.

$$sizeof ( acc ) = ( \frac{r}{2 m + 1} + 2 m ) \cdot ( \frac{c}{2 n + 1} + 2 n ) + 1 \qquad [ Equation 2 ]$$

According to equation 2, sizeof(acc) represent the size of the cumulative matrix, r represents the cumulative matrix, c represents the row of the cumulative matrix, m represents the pixels of the sample distance corresponding to the x-axis, n represents the pixels of the sample distance corresponding to the y-axis.

According to an embodiment of the present invention, the electronic device can calculate the pixels of the sample distance corresponding to the maximum x-axis using Equation (3). Equation 3 is as follows.

$$\frac{\partial }{\partial m} ( sizeof ( acc ) ) = ( - \frac{2 r}{{( 2 m + 1 )}^{2}} + 2 ) ( \frac{c}{2 n + 1} + 2 n ) \qquad [ Equation 3 ]$$

According to equation 3, sizeof(acc) represents the size of the cumulative matrix, r represents the column of the cumulative matrix, c represents the row of the cumulative matrix, m represents the pixels of the sample distance corresponding to the x axis, and n represents the pixels of the sample distance corresponding to the y axis.

According to an embodiment of the present invention, the electronic device can calculate the pixels of the sample distance corresponding to the maximum y-axis using Equation (4). Equation (4) is as follows.

$$\frac{\partial }{\partial n} ( sizeof ( acc ) ) = ( - \frac{2 c}{{( 2 n + 1 )}^{2}} + 2 ) ( \frac{r}{2 m + 1} + 2 m ) \qquad [ Equation 4 ]$$

According to equation 4, sizeof(acc) represents the size of the cumulative matrix, r represents the column of the cumulative matrix, c represents the row of the cumulative matrix, m represents the pixels of the sample distance corresponding to the x axis, and n represents the sample distance corresponding to the y axis.

According to an embodiment of the present invention, when m and n calculated through Equations 3 and 4 are excluded from Equation (2), the electronic device can calculate an cumulative matrix of the minimum size.

In step 511, the electronic device may determine the position of the template based on the maximum of the second voting cumulative values and the maximum among the third voting cumulative values.

The electronic device can determine the position of the block corresponding to the maximum value among the second voting cumulative values as the center position of the template.

For example, the electronic device may determine the center position of the template through the maximum of the second voting cumulative values.

For example, the electronic device may determine the exact position of the template by estimating the position of the template using the second voting cumulative values and then by determining the position of the corrected template using the voting cumulative values for estimated position.

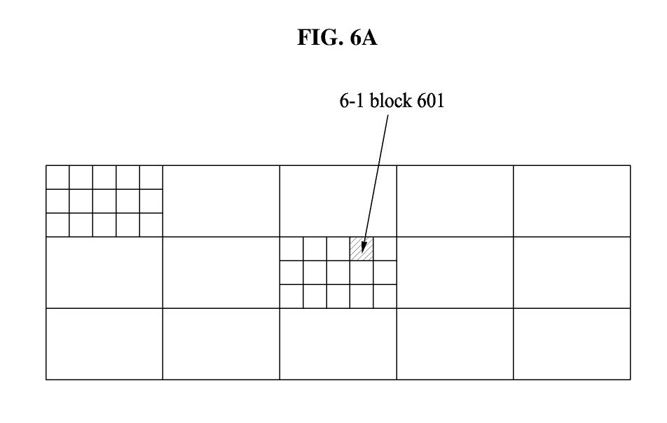

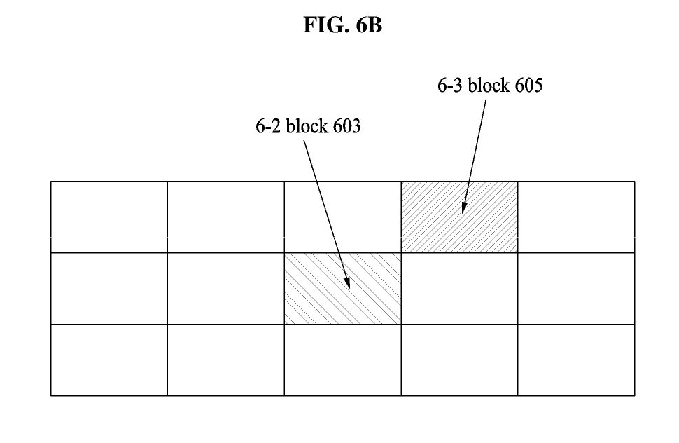

FIGS. 6A and 6B illustrate blocks in which double voting is performed to determine the position of a template according to an embodiment of the present invention.

Specifically, FIGS. 6A and 6B illustrate blocks in which an electronic device performs double voting to determine the location of a template.

Referring to FIG. 6A, the electronic device performs the voting on blocks corresponding to the horizontal axis and the vertical axis of the edge of the object to determine the position of the template.

Here, the voting for the blocks corresponding to the horizontal axis and the vertical axis may be referred to as a second voting

The electronic device may cumulates the values voted in the blocks to generate an cumulative matrix, and may calculate the voting cumulative value based on the cumulative matrix.

For example, the voting cumulative value may be referred to as a second voting cumulative value.

The electronic device determines the maximum value among the voting cumulative values and determines the block corresponding to the maximum value as the center position of the template.

For example, the electronic device can determine the center position of the template through the maximum value of the voting cumulative values.

The center position of the template determined by the electronic device includes 6-1 block 601.

FIG. 6B illustrates blocks in which the electronic device down-samples the block including the 6-1 block 601.

The electronic device performs the voting on the blocks included in the down sampled block.

The electronic device may generate the cumulative matrix as accumulating the voted values of blocks and calculates the voting cumulative values based on the cumulative matrix.

Here, the voting cumulative values may be referred to as the third voting cumulative values.

The electronic device can determine a block corresponding to the maximum value among the third voting values as the center position of the template.

Here, the block corresponding to the maximum value among the third voting cumulative values is the 6-2 block 603.

The electronic device can determine the largest value next to the maximum value by referring to the third voting cumulative values.

Here, the block corresponding to the largest value next to the maximum value may be a 6-3 block 605.

The electronic device may store the location of blocks in accordance with the third voting cumulative values in a storage.

The electronic device may recognize that 6-1 block 601 and 6-3 block 605 in the resolution represent the same position before performing down sampling.

Further, in order to determine the position of the template, the electronic device can more accurately determine the position of the template through two rounds of the blocks corresponding to the horizontal axis and the vertical axis among the edge detected from the object.

Methods according to the claims or the embodiments described in the specification may be implemented in hardware, software, or a combination of hardware and software.

Such software may be stored in a computer-readable storage medium. The computer-readable storage medium includes at least one program (software module), at least one program including instruction that cause the electronic device to implement the method of the present invention in case executed by the at least one processor in an electronic device.

Such software may store in the form of non-volatile storage such as volatile or read only memory (ROM), or in form of memory such as Random access memory, memory chip, device or integrated circuit memory chips, or in form of optical or magnetic readable medium such as Compact Disc-ROM, digital versatile disks (DVDs), magnetic disks, magnetic tape or the like.

The storage device and storage medium are embodiments of machine-readable storage means suitable for storing programs or programs, including instructions that, when executed, implement the embodiments.

Embodiments provide a program including code for implementing an apparatus or method as claimed in any one of the claims herein, and a machine-readable storage medium storing such a program.

Further, such programs may be electronically delivered by any medium, such as a communication signal carried over a wired or wireless connection, and the embodiments suitably include equivalents.

In the above-mentioned specific embodiments, elements included in the invention have been expressed singular or plural in accordance with the specific embodiments shown.

It should be understood, however, that the singular or plural representations are selected appropriately according to the situations presented for the convenience of description and that the above-described embodiments are not limited to the singular or plural constituent elements, while they may be composed of a plurality of elements even if they are represented by singular values, or while they may be composed of singular values even if they are represented by a plurality of elements.

While the invention has been shown and described with reference to certain preferred embodiments thereof, it will be understood by those skilled in the art that various changes and modifications may be made without departing from the spirit and scope of the invention as defined by the appended claims.

Therefore, the scope of the present invention should not be construed as being limited to the embodiments described, but should be determined by the equivalent scope of the appended claims, as well as the appended claims.

### DESCRIPTION OF SYMBOLS

100: ELECTRONIC DEVICE
120: CAMERA UNIT
140: STORAGE UNIT
160: CONTROL UNIT
161: EDGE DETECTION UNIT
162-1: THE FIRST VOTING UNIT
162-2: THE SECOND VOTING UNIT
162-3: THE THIRD VOTING UNIT
163-1: THE FIRST VOTING CALCULATING UNIT
163-2: THE SECOND VOTING CALCULATING UNIT
163-3: THE THIRD VOTING CALCULATING UNIT
164: ROTATION ANGLE DETERMINING UNIT
165: RESOLUTION ADJUSTING UNIT
166: POSITION DETERMINING UNIT
167: REFERENCE IMAGE SETTING UNIT
168: HISTOGRAM OPERATING UNIT
169: TEMPLATE POSITION ESTIMATING UNIT
170: WEIGHT ADDING UNIT
171: REFERENCE BLOCK DETERMINING UNIT

What is claimed is:

1. An apparatus for inspecting a template, comprising:
a rotation angle determining unit for determining a rotation angle of a template included in the object by performing a first voting procedure on a input image including an object; and
a position determining unit for calculating a voting cumulative values for blocks included in the input image by performing a second voting procedure on the input image, performing a down sampling at least one of the blocks based on the voting cumulative values, and determining a position of the template by performing a third voting procedure on the down sampled blocks.

2. The apparatus according to claim 1, further comprising:
an edge detection unit for detecting the object and the edge of the template as block units based on a horizontal axis, a vertical axis and a diagonal axis from the input image.

3. The apparatus according to claim 2, wherein the rotation angel determining unit comprising:
a first voting unit for performing a first voting on first blocks corresponding to a diagonal axis of the edge; and
a first voting calculating unit for calculating first voting cumulative values for the first blocks and determines a rotation angle of the template based on the first voting cumulative values.

4. The apparatus according to claim 2, wherein the position determining unit comprising:
a second voting unit for performing a second voting on second blocks corresponding to a horizontal axis and third blocks corresponding to a vertical axis among the blocks corresponding to the edge;
a second voting calculating unit for calculating second voting cumulative values for the second blocks and the third blocks and determining a maximum value among the second voting cumulative values;
a resolution adjusting unit for performing down-sampling on a block corresponding to the maximum value among the second voting cumulative values;
a third voting unit for performing a third voting on fourth blocks included in the down sampled block; and
a third voting calculating unit for calculating third voting cumulative values for the fourth blocks and determines the position of template based on the maximum value among the second voting cumulative values and the maximum value among the third voting cumulative values.

5. The apparatus according to claim 4, wherein the position determining unit comprising:
a template position estimating unit for estimating blocks to be located the template among the blocks corresponding to the edge; and
a weight adding unit for adding a weight to blocks to be located the template.

6. The apparatus according to claim 5, wherein the third voting unit performs voting the fourth blocks in consideration of the weight added to the blocks

7. The apparatus according to claim 4, wherein the position determining unit comprises a reference block determining unit for designating a block corresponding to a maximum value among the second voting cumulative values as a first reference block and for designating a block corresponding to the maximum value among the third voting cumulative values as a second reference block.

8. The apparatus according to claim 7, wherein the first reference block is located at a center position among blocks performed the second voting, and wherein the second reference block is located at a center position among the blocks performed the third voting.

9. The apparatus according to claim 4, wherein the rotation angle determining unit comprises a histogram operating unit for converting the reference image including the object and the object into a histogram, and for calculating a histogram correlation value between the object and the reference image.

10. The apparatus according to claim 9, wherein the rotation angle determining unit determines the rotation angle of the template based on the histogram correlation value regardless of the size of the template.

11. The method for inspecting a template, comprising:
determining a rotation angle of a template included in the object by performing a first voting procedure on a input image including an object;
calculating voting cumulative values for blocks included in the input image by performing a second voting procedure on the input image;
performing a down sampling at least one of the blocks based on the voting cumulative values;
determining a position of the template by performing a third voting procedure on the down sampled blocks.

12. The method according to claim 11, further comprising:
detecting the object and an edge of the template as block units based on a horizontal axis, a vertical axis and a diagonal axis from the input image.

13. The method according to claim 12, wherein, in determining the rotation angle of template, comprising:
performing a first voting on first blocks corresponding to a diagonal axis of the edge;
calculating first voting cumulative values for the first blocks; and
determining the rotation angle of the template based on the first voting cumulative values.

14. The method according to claim 12, wherein, in determining the position of template, comprising;
performing a second voting on the second blocks corresponding to a horizontal axis and the third blocks corresponding to a vertical axis among the blocks corresponding to the edge;
calculating second voting cumulative values for the second blocks and the third blocks, and determining a maximum value among the second voting cumulative values;
performing a down-sampling on a block corresponding to the maximum value among the second voting cumulative values;
performing a third voting on the fourth blocks included in the down sampled block;
calculating third voting cumulative values for the fourth blocks and determining the maximum value among the second voting cumulative values; and
determines the position of template based on the maximum value among the second voting cumulative values and the maximum value among the third voting cumulative values.

15. The method according to claim 14, further comprising:
estimating blocks to be located the template among the blocks corresponding to the edge; and
adding a weight to blocks to be located the template.
